(19) United States
(12) Patent Application Publication
(10) Pub. No.: US 2026/0084340 A1
(43) Pub. Date: Mar. 26, 2026

(54) METHOD FOR PRODUCING PLATE-SHAPED WORKPIECES AND MACHINING MACHINE

(71) Applicant: HOMAG GmbH, Schopfloch (DE)

(72) Inventors: Andreas WINTER, Schopfloch (DE); Andreas LORENZ, Dornstetten (DE)

(21) Appl. No.: 19/332,893

(22) Filed: Sep. 18, 2025

(30) Foreign Application Priority Data
Sep. 20, 2024 (DE) 10 2024 127 125.6

(51) Int. Cl. B27M 3/00; B27M 3/06

(52) U.S. Cl. CPC B27M 3/0066; B27M 3/06

(57) ABSTRACT

The invention relates to a method for producing plate-shaped workpieces (15) preferably consisting at least in parts of wood, a wood material, plastic, composite material and/or mixed material or the like, said method comprising the steps of: providing a plate-shaped base workpiece (10), introducing at least one groove (11) into a surface (12) of the base workpiece (10), at least one design element (13) and at least one reference element (16) being formed when introducing the groove (11), aligning the base workpiece (10) and/or a processing device in dependence on the at least one reference element (16) formed, and dividing the base workpiece (10) into at least two plate-shaped workpieces (15). The invention furthermore relates to a processing machine.

### TECHNICAL FIELD

The invention relates to a method for producing plate-shaped workpieces and to a processing machine for producing plate-shaped workpieces.

### PRIOR ART

In order to produce plate-shaped workpieces, for example floor, ceiling or wall panels, large-format initial workpieces are generally used, which are divided into a plurality of smaller workpieces by a processing machine. In subsequent processing steps, this plurality of workpieces can be processed further, for example formatted, contoured and printed or also provided with corresponding connecting members on the narrow surfaces thereof, for instance for a tongue and groove connection. In order to further improve the processing quality and visual appearance of such floor, ceiling or wall panels, to reduce the processing times and material waste during production and to reduce manufacturing costs, processing machines for producing such plate-shaped workpieces are subject to continuous further development.

### DESCRIPTION OF THE INVENTION

The invention is based on the object of providing a method for producing plate-shaped workpieces as well as a processing machine for producing plate-shaped workpieces, which enables a high-quality and fast as well as material-and cost-optimised production of plate-shaped workpieces.

A method for producing plate-shaped workpieces is defined in claim 1. A processing machine for producing plate-shaped workpieces is defined in claim 13. Dependent claims relate to specific embodiments.

According to the invention, the object is solved by means of a method for producing plate-shaped workpieces, said method comprising the steps of providing a plate-shaped base workpiece, introducing at least one groove into a surface of the base workpiece, with at least one design element and at least one reference element being formed when introducing the groove, aligning the base workpiece and/or a processing device in dependence on the at least one reference element formed, and dividing the base workpiece into at least two plate-shaped workpieces.

The plate-shaped workpieces produced by the method according to the invention may preferably be panels, in particular floor, ceiling and/or wall panels. The plate-shaped workpieces may also be elements for producing furniture, for example furniture fronts, for producing doors or the like. The workpieces in particular consist at least in parts of wood, a wood material, plastic, composite material and/or mixed material or the like. The provided plate-shaped base workpiece is preferably a large-format initial workpiece, which is divided into the at least two plate-shaped workpieces by subsequent processing steps.

The at least one groove is preferably introduced on a side of the base workpiece that forms the upper sides of the finished plate-shaped workpieces. The at least one groove can preferably be formed by machining, for example by milling. When introducing the at least one groove, the at least one design element, which forms a workpiece edge on at least one of the finished workpieces, and the at least one reference element, which is provided for aligning the base workpiece and/or the processing device, are preferably formed in a single processing step. For example, the at least one groove can be introduced into the surface of the base workpiece simultaneously with the at least one design element and the at least one reference element, preferably by means of just one processing tool, in particular a milling tool. Alternatively, a plurality of processing tools may also be provided, by means of which, in a preferably continuous processing operation, the at least one groove is first of all introduced into the surface of the base workpiece and then the at least one design element and the at least one reference element are formed on the groove.

In a further development of the method, it may be provided that the base workpiece is divided such that the at least one design element and the at least one reference element are retained on at least one of the at least two plate-shaped workpieces.

In other words, the base workpiece is divided such that a separating cut for dividing the base workpiece is made adjacent to the at least one groove, as a result of which the at least one design element and the at least one reference element are retained on at least one of the at least two plate-shaped workpieces. For example, a separating cut for dividing the base workpiece may be provided at a distance of at most 20 mm, preferably at most 10 mm, more preferably at most 5 mm, from the at least one groove. In this way, the at least one reference element for subsequent processing steps to align the respective plate-shaped workpiece and/or a processing device as well as the at least one design element can be retained on the respective plate-shaped workpiece in order to form a correspondingly configured workpiece edge on the finished workpiece.

A preferred configuration of the method may furthermore provide that the at least one design element and the at least one reference element are formed at a distance to one another and/or at least in sections along a longitudinal extension of the at least one groove.

The at least one groove is preferably introduced into the surface of the base workpiece along a complete length and/or width of the base workpiece, i.e. from one edge region to an opposite edge region of the base workpiece. The at least one groove can thereby be introduced into the surface both in a flat section of the top and/or bottom side and at an edge region of the base workpiece. An extension length of the at least one groove advantageously corresponds to at least one length and/or width of the finished plate-shaped workpieces. The at least one groove is preferably formed with a linear course. The at least one groove may also be formed with any other course, for example a free form course. By forming the at least one design element and the at least one reference element at a distance to one another, a reliable differentiation between the design element and the reference element can be achieved for subsequent processing steps, in particular in order to be able to identify or detect the reference element for alignment.

In the method, the at least one design element and the at least one reference element can preferably be formed at a distance of at most 5 mm, preferably at most 3 mm, more preferably at most 2 mm.

By means of such a distance between the at least one design element and the at least one reference element, material waste can be minimised since, in a subsequent processing step, starting from the design element in the direction of the reference element, only a small amount of workpiece material needs to be removed in order to form the design element as a workpiece edge on the finished workpiece. In addition, owing to such a distance between the at least one design element and the at least one reference element, a reliable differentiation between the design element and the reference element can be achieved.

In the method, the at least one design element may more preferably be formed at an edge region of the at least one groove and/or the at least one reference element may be formed at an opposite edge region of the at least one groove. The at least one design element is preferably formed as a chamfer, a rebate, a shoulder, a rounding or the like at the edge region of the at least one groove. The at least one reference element is preferably formed as an edge, a surface, an inclined surface or the like at the opposite edge region of the at least one groove.

A base portion of the at least one groove may be formed between the at least one design element and the at least one reference element. The base portion extends, in accordance with the longitudinal extension of the at least one groove, between the at least one design element and the at least one reference element. The distance between the at least one design element and the at least one reference element may be defined by the width of the base portion.

The provision of the at least one design element and the at least one reference element at the edge regions enables a simple formation of the at least one groove together with the design element and the reference element. In this case, it may either be provided that the at least one groove is formed together with the at least one design element and the at least one reference element by means of just one correspondingly configured processing tool, in particular a milling tool, or it may be provided that the at least one groove is first of all formed by the processing tool and, in a subsequent processing operation, the two edge regions of the at least one groove are correspondingly formed by the same or a further processing tool in order to form the at least one design element and the at least one reference element at the edge regions.

A preferred configuration of the method may provide that the at least one reference element is formed so as to be inclined at an angle of inclination of at least 40°, preferably at least 50°, more preferably at least 60°, relative to a main extension plane of the plate-shaped base workpiece. The at least one reference element configured as an inclined surface is in particular formed so as to be inclined at an angle of inclination of at least 40°, preferably at least 50°, more preferably at least 60°, relative to a main plane of extension of the plate-shaped base workpiece. By forming the inclined surface at such an angle of inclination, an optimum differentiation between the reference element and the remaining surface of the base workpiece can be achieved. As a result hereof, reliable identification and detection of the at least one reference element by a detection device, in particular a sensor and/or camera device, can be achieved for the alignment.

In an advantageous configuration of the method, at least one pair of adjacent grooves may be introduced into the surface of the base workpiece, the reference elements being formed at the facing edge regions of the pair of adjacent grooves and the base workpiece being divided into the plate-shaped workpieces between the reference elements of the pair of adjacent grooves.

In other words, grooves can preferably be introduced into the surface of the base workpiece in pairs at a distance to one another. The distance between the at least one pair of adjacent grooves may be at most 50 mm, preferably at most 40 mm, more preferably at most 30 mm, more preferred at most 20 mm. The at least one pair of adjacent grooves is advantageously formed in a parallel arrangement to one another. By dividing the base workpiece between the reference elements of the pair of adjacent grooves, it can in particular be provided that, by means of the division, the grooves with the formed design elements and the reference elements are retained without processing.

In an advantageous further development of the method, it may furthermore be provided that at least the design elements of the pair of adjacent grooves are formed mirror-symmetrical to one another.

In this way, it can be achieved that the design elements are arranged on the sides of the paired grooves that face away from one another, which, after division of the base workpiece, are assigned to the plate-shaped workpieces such that the design elements can form the workpiece edges of the finished plate-shaped workpieces. In other words, with the mirror-symmetrical configuration of the design elements, it can be provided that the design elements are formed at the edge regions of the paired grooves that face away from one another. The pair of adjacent grooves can, in a particularly advantageous manner, be formed mirror-symmetrical to one another.

A particularly preferred further development of the method may furthermore provide that a plurality of pairs of adjacent grooves are introduced into the surface of the base workpiece and that the base workpiece is in each case divided into a plurality of plate-shaped workpieces between the reference elements of a pair of adjacent grooves.

The number of pairs of adjacent grooves introduced into the surface of the base workpiece may be any number of pairs and may depend, for example, on the size of the base workpiece and/or the quantity of workpieces to be produced from the base workpiece. For example, 2, 3, 4, 5, 10 or more pairs of adjacent grooves may be introduced into the surface of the base workpiece in order to divide the base workpiece into 3, 4, 5, 6, 11 or more plate-shaped workpieces.

In a further development of the method, the surface of the base workpiece may be printed and/or coated, at least in some areas, after introduction of the at least one groove and before division of the base workpiece, with a printing unit for printing and/or coating being aligned in dependence on the at least one reference element.

During printing and/or coating, it may preferably be provided that the entire surface of the base workpiece is printed and/or coated by the printing unit after introduction of the groove and before division of the base workpiece. The entire surface of the base workpiece in particular comprises an area that forms the upper sides of the finished plate-shaped workpieces as well as an area that is formed by the at least one introduced groove. In other words, the entire surface of the base workpiece, in particular including the at least one design element, the at least one reference element and/or the base portion of the groove, is preferably printed and/or coated by the printing unit.

Alternatively, it may also be provided that the printing unit only prints and/or coats that surface of the base workpiece which forms the upper sides of the finished plate-shaped workpieces as well as the at least one design element which forms the workpiece edge on the finished workpieces.

The printing unit can be precisely controlled in dependence on the at least one reference element in order to form a high-quality print image. For this purpose, the at least one reference element can be detected by a detection device, in particular a sensor and/or camera device, which is coupled to the printing unit for control of the same.

The method can advantageously be configured in such a manner that the narrow sides of the plate-shaped workpieces formed by dividing the base workpiece are processed such that the at least one reference element is removed, preferably by machining, and the at least one design element is retained as the workpiece edge of the plate-shaped workpiece.

Both the at least one reference element as well as the base portion of the groove, i.e. the area of the groove formed between the reference element and the design element, and/or any workpiece overhang can be removed preferably by machining. It is thereby in particular provided that the at least one design element is not processed in order to form a workpiece edge on the finished plate-shaped workpiece.

By means of the preferred machining of the narrow sides of the plate-shaped workpieces formed by dividing the base workpiece, connecting members that correspond to one another can preferably be formed on these narrow sides. These corresponding connecting members may in particular be configured to, for example when producing panels, enable the panels to be connected later. The connecting members may, for example, form a tongue and groove connection for connecting the plate-shaped workpieces to one another. In addition, a reference edge may be formed on the base workpiece or on the plate-shaped workpieces, preferably by machining, in order to provide a defined alignment for longitudinal profiling.

A processing machine for producing plate-shaped workpieces, in particular using the method according to one of the embodiments described above, is defined in claim 13 and serves to realise the aforementioned advantages.

The processing machine comprises a conveying device for bringing about a conveying movement of a base workpiece, a processing device for introducing at least one groove into a surface of the base workpiece, the processing device comprising at least one processing tool by means of which at least one design element and at least one reference element can be formed when introducing the at least one groove, at least one processing tool for dividing the base workpiece into at least two plate-shaped workpieces, and an aligning device by means of which the base workpiece and/or the at least one processing tool for dividing the base workpiece can be aligned in dependence on the at least one reference element.

Such a processing machine may be configured as a throughfeed machine, in which the base workpieces are moved by the conveying device in a conveying direction relative to the processing device, i.e. processing of the base workpieces is provided in a continuous process. The processing machine may be configured as a CNC-controlled processing machine or as a CNC-controlled machining centre. The processing machine may alternatively also be configured as a stationary machine tool, in which the base workpiece to be processed is held in a stationary manner and a processing unit moves in order to carry out a processing operation.

The base workpiece for producing the plate-shaped workpieces is, in particular, a workpiece formed at least in parts of wood, a wood material, plastic, composite material and/or mixed material or the like. The plate-shaped workpieces that can be produced from the base workpiece are preferably panels, in particular floor, ceiling or wall panels, or elements for furniture production, door production or the like.

A particularly advantageous further development of the processing machine may provide that at least one printing unit is provided between the processing device for introducing the at least one groove and the at least one processing tool for dividing the base workpiece, the printing unit being alignable in dependence on the at least one reference element in order to print and/or coat the surface of the base workpiece at least in some areas.

Such a printing unit is preferably configured as a digital printing unit. The printing unit is in particular an inkjet printing device. The printing unit can perform a multicolour printing operation and/or a single-colour printing operation. By means of such a printing unit, both multicoloured workpiece patterns, for example a replica wood grain or the like, as well as single colour tones can be applied to the surface of the base workpiece and/or the plate-shaped workpieces. The printing unit may be arranged on a positioning device, by means of which a single-axis or multi-axis positioning movement of the printing unit relative to the base workpiece and/or the plate-shaped workpieces can be carried out. The printing unit is in particular coupled to a detection device, for example a detection device comprising one or more cameras and/or sensor members, by means of which the at least one reference element can be detected in order to control the printing unit to execute the printing and/or coating operation in dependence on the reference element.

In a further configuration of the processing machine, at least one processing unit may be provided, by means of which the narrow sides of the plate-shaped workpieces formed by dividing the base workpiece can be processed such that the at least one reference element is removed preferably by machining, and the at least one design element is retained as the workpiece edge of the plate-shaped workpiece.

The at least one processing unit in particular comprises at least one processing tool, in particular a milling tool, by means of which connecting members can be formed on the narrow sides of the plate-shaped workpieces formed by dividing the base workpiece. By forming the connecting members, at least the at least one reference element and the base portion of the groove can thereby be at least substantially removed and the at least one design element can be retained unprocessed as the workpiece edge on the plate-shaped workpiece. The processing tool may preferably be configured to form a tongue and groove connection on the narrow sides of the plate-shaped workpieces formed by dividing the base workpiece in order to join the plate-shaped workpieces together.

### BRIEF DESCRIPTION OF THE DRAWINGS

Further features and advantages of a device, a use and/or a method are apparent from the following description of embodiments with reference to the accompanying drawings. These drawings show the following:

FIG. 1 a flow chart of a method for producing plate-shaped workpieces according to an embodiment according to the disclosure;

FIG. 2 a schematic top view of a base workpiece for producing a plurality of plate-shaped workpieces;

FIG. 3 a schematic partial sectional view of the base workpiece in FIG. 2;

FIG. 4 a schematic detailed view of a groove introduced into the base workpiece;

FIG. 5 a schematic sectional view of a plate-shaped workpiece produced by the method according to the disclosure.

### DESCRIPTION OF EMBODIMENTS

Identical reference numbers used in different figures designate identical, corresponding or functionally similar elements.

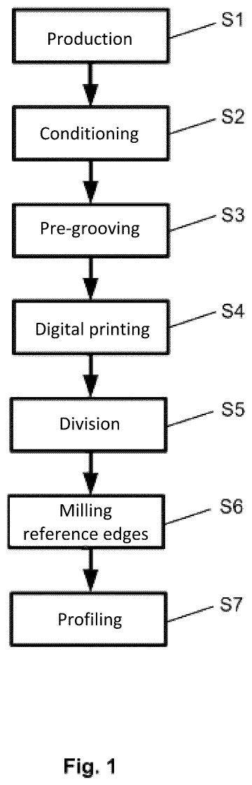

FIG. 1 shows a flow chart of a method for producing plate-shaped workpieces according to an embodiment according to the disclosure.

By means of the method according to the invention, a plurality of plate-shaped workpieces are produced from large-format initial workpieces, hereinafter referred to as the base workpiece, by dividing the initial workpiece into the plurality of plate-shaped workpieces. The produced plate-shaped workpieces are preferably panels, in particular floor, ceiling and/or wall panels, or plate-shaped elements for producing furniture, for example furniture fronts, for producing doors or the like.

In a first method step S1, an initial workpiece is produced or generally provided as a plate-shaped base workpiece 10 for the production of the plate-shaped workpieces. Such a plate-shaped base workpiece 10 is schematically shown in FIG. 2, to which the following descriptions refer.

The base workpiece 10 may be produced in various ways within the scope of the invention, for example also by means of an extrusion process. The base workpiece 10 may, for example, be an initial workpiece that consists at least in parts of a plastic, composite material and/or mixed material, wood material or the like and is possibly produced by extrusion. The base workpiece 10 may also consist at least in parts of wood. The base workpiece 10 may, for example, be assembled, e.g. glued and/or pressed together, from a plurality of elements. The plate-shaped base workpiece 10 may, for example, be a solid wood board or chipboard, a lightweight board, a layered board, or the like.

In a second method step S2, the plate-shaped base workpiece 10 is conditioned. Conditioning of the base workpiece 10 may, for example, include cooling the base workpiece 10 after the extrusion process, formatting the base workpiece 10 to a defined dimension or shape and/or another type of preparatory processing step.

In a third method step S3, a plurality of grooves 11 are introduced into a surface 12 of the base workpiece 10, as shown in particular in FIG. 2.

The grooves 11 are introduced into the surface 12 of the base workpiece 10 by a processing machine that is not shown in more detail. Such a processing machine may preferably be a throughfeed machine, in which processing of the base workpiece 10 is provided in a continuous process. The processing machine may also be a stationary processing machine, in which the base workpiece 10 is held in a stationary manner for a processing operation. The processing machine may be configured as a CNC-controlled processing machine or form a CNC-controlled machining centre. The processing machine is in particular configured to process workpieces that are made at least in parts of wood, a wood material, plastic, composite material and/or mixed material or the like. It should be understood, however, that the processing machine is not limited to processing such workpieces and/or materials.

The processing machine is in particular configured such that a plurality of base workpieces 10 are fed in succession to the processing machine and are conveyed relative to the processing machine. For this purpose, the processing machine may comprise a conveying device on which the base workpieces 10 rest. The conveying device may be configured as a conveyor belt or conveyor chains, for example.

The processing machine comprises one or more processing tools for introducing the plurality of grooves 11 into the surface 12 of the base workpiece 10. The one or more processing tools are preferably milling tools for milling, by means of which the plurality of grooves 11 are introduced into the base workpiece 10. For this purpose, the processing machine may advantageously comprise a plurality of processing tools, such that a plurality grooves 12 are introduced simultaneously or almost simultaneously into the surface 12 of the base workpiece 10.

The one or more processing tools are in particular configured such that when introducing the groove 12, they form a design element 13 that forms a workpiece edge 14 on a finished plate-shaped workpiece 15 as well as a reference element 16 that is provided for aligning the base workpiece 10 and/or the processing device. The grooves 11 are in particular introduced into the surface 12 on a side of the base workpiece 11 that forms the upper sides 17 of the subsequent plate-shaped workpieces 15.

The design element 13 and the reference element 16 may be formed simultaneously, preferably using just one processing tool, in particular a milling tool, when introducing the respective groove 11. In other words, a groove 11 is preferably introduced into the surface 12 of the base workpiece 10 together with the design element 13 and the reference element 16 in a single processing operation.

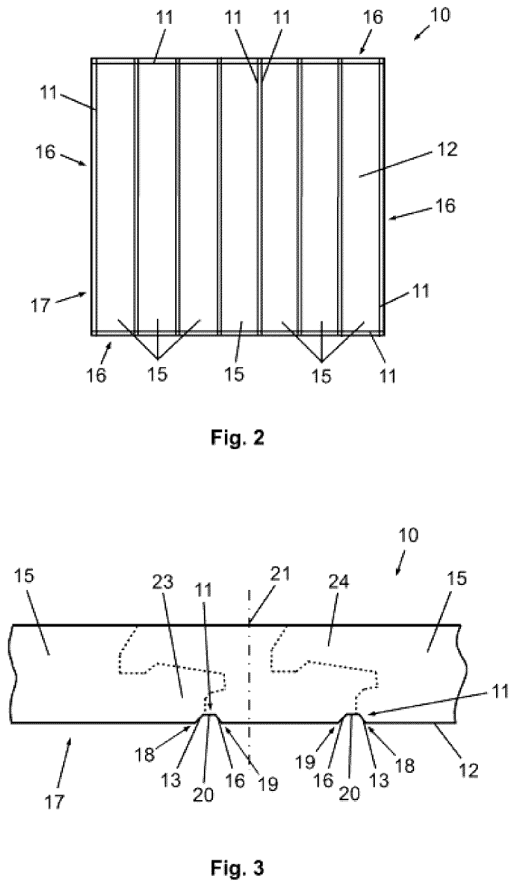

As shown in FIGS. 2 and 3, the grooves 11 are each introduced into the surface 12 of the base workpiece 10 in pairs of adjacent grooves 11, the base workpiece 10 being divided into the respective plate-shaped workpieces 15 between the pairs of adjacent grooves 11 in a subsequent method step. The pairs of adjacent grooves 11 are each introduced into the surface 12 of the base workpiece 10 at a distance of at most 50 mm, preferably at most 40 mm, more preferably at most 30 mm, more preferred at most 20 mm, from one another, with the pairs of adjacent grooves 11 being formed parallel to one another.

The pairs of adjacent grooves 11 are each formed mirror-symmetrical to one another, the design elements 13 of the pair of adjacent grooves 11 being formed at the edge regions 18 of the grooves 11 facing away from one another and the reference elements 16 of the pair of adjacent grooves 11 being formed at the edge regions 19 of the grooves 11 facing one another, i.e. adjacent to one another, as shown in FIG. 3.

FIG. 2 shows, by way of example, that 6 pairs of adjacent grooves 11 are introduced into the base workpiece 10. A groove 11 is additionally formed at each edge region 16 of the base workpiece 10. The grooves 11 can therefore be formed in both a longitudinal direction and a transverse direction of the base workpiece 11.

By means of the 6 pairs of adjacent grooves 11, 7 plate-shaped workpieces 15 can be produced from the base workpiece 10. It should be understood that the number of pairs of adjacent grooves 11 introduced into the surface 12 of the base workpiece 10 may be any number. For example, 2, 3, 4, 5, 10 or more pairs of adjacent grooves 11 may also be introduced into the surface 12 of the base workpiece 10 in order to be able to divide the base workpiece 10 into 3, 4, 5, 6, 11 or more plate-shaped workpieces 15. The number of grooves 11 may be selected depending on the number of plate-shaped workpieces 15 to be produced and/or the size of the base workpiece 10.

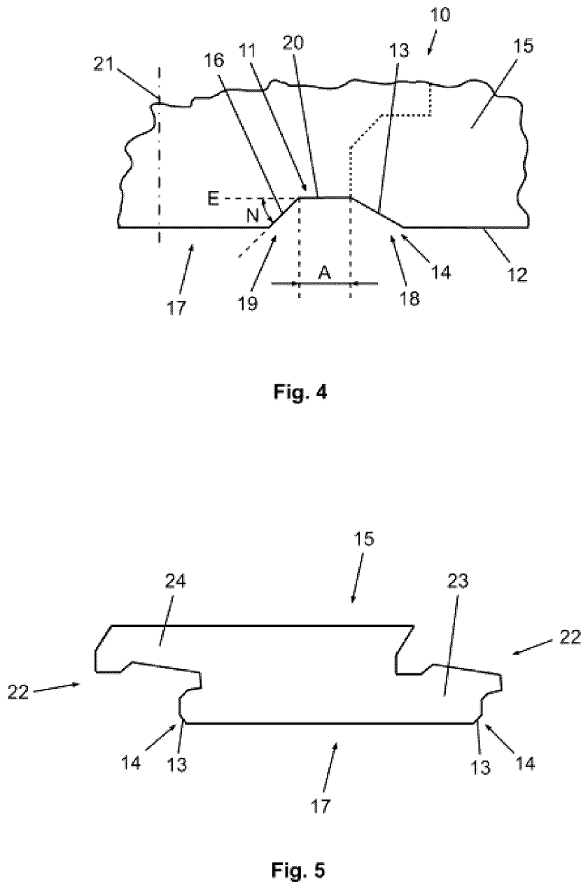

FIG. 4 shows a schematic partial sectional view of the base workpiece 10, in which a cross-section of one of the grooves 11 is shown in detail.

The grooves 11 are introduced into the surface 12 of the base workpiece 11 along a longitudinal extension. The design element 13 is thereby formed along an edge region 18 of a groove 11. According to the embodiment shown in FIG. 4, the design element 13 is configured as a chamfer. Alternatively or additionally, the design element 13 may also be formed as a rebate, a shoulder, a rounding or another shape along the edge region of the groove 11.

The reference element 16 is formed along the opposite edge region 19 of the groove 11, the reference element 16 being formed as an inclined surface along the edge region 19 of the groove 11. This inclined surface has an angle of inclination N of at least 40°, preferably at least 50°, more preferably at least 60°, relative to a main extension plane E of the base workpiece 10. Alternatively or additionally, the reference element 16 may also be formed as an edge, a rebate, a surface or the like at the edge region of the groove 11.

A base portion 20 is formed between the design element 13 and the reference element 16, such that the design element 13 and the reference element 16 are spaced apart from one another. The base portion 20 extends along the longitudinal extension of the groove 11 between the design element 13 and the reference element 16.

The design element 13 and the reference element 16 are formed at a distance A of at most 5 mm, preferably at most 3 mm, more preferably at most 2 mm.

In a fourth method step S4, the surface 12 of the base workpiece 10 is printed, lacquered and/or coated by a (printing) unit after introduction of the grooves 11.

The printing unit may either be part of the processing machine or may also be provided separately from the processing machine. The printing unit is in particular provided after method step S3 for introducing the plurality of grooves 11 and before a subsequent method step S5 for dividing the base workpiece 10 into the plurality of plate-shaped workpieces 15.

The printing unit is in particular a digital printing unit. The printing unit may be an inkjet printing device that can perform multicolour printing operations and/or single-colour printing operations. By means of the printing unit, multicoloured workpiece patterns, for example a replica wood grain or the like, and single-colour patterns can thus be printed on the surface 12 of the base workpiece 10. By means of a positioning device, a single-axis or multi-axis positioning movement of the printing unit relative to the base workpiece 10 can be controlled for the printing and/or coating operation.

The printing unit may be coupled to a detection device which, with the aid of one or more cameras and/or sensors, detects at least one of the reference elements 16 in order to control the printing unit to perform the printing and/or coating operation in dependence on at least one detected reference element 16. Alternatively or additionally, the workpiece may also be aligned, for example, by means of at least one stop or other mechanical elements.

In the printing and/or coating operation, it is preferably provided that the entire surface 12 of the base workpiece 10 is printed and/or coated. The entire surface 12 is to be understood here as those surface areas of the base workpiece 10 that form the upper sides 17 of the finished plate-shaped workpieces 15, as well as those surface areas that are formed by the plurality of grooves 11, i.e. the design elements 13, the reference elements 16 and the base portions 18. In other words, by means of the printing and/or coating operation, the surface 12 of the base workpiece 10 is printed and/or coated together with the design elements 13, reference elements 16 and base portions 18 formed by the introduction of the grooves 11.

It may alternatively also be provided during the printing and/or coating operation that only those surface areas of the base workpiece 10 are printed and/or coated which form the upper sides or visible sides 17 of the finished plate-shaped workpieces 15, as well as those surface areas that are formed by the design elements 13 of the grooves 11.

In a fifth method step S5, the base workpiece 10 is divided into the plurality of plate-shaped workpieces 15. The processing machine is coupled to a detection device which, with the aid of one or more cameras and/or sensors, detects at least one of the reference elements 16 in order to control the processing machine to perform the processing operation in dependence on at least one detected reference element 16.

A dividing line 21 between the pair of adjacent grooves 11 is shown, by way of example, in FIG. 3 to indicate a position for the introduction of a separating cut for dividing the base workpiece 10.

The base workpiece 10 is divided between the respective pair of adjacent grooves 11 such that the design elements 13 and the reference elements 16 are retained on the respective divided plate-shaped workpieces 15. The processing machine comprises one or more processing tools, in particular one or more sawing tools, for dividing the base workpiece 11, by means of which the base workpiece 10 is divided into the plurality of plate-shaped workpieces 15. A plurality of processing tools are preferably arranged parallel to one another in order to divide the base workpiece 10 into the plurality of plate-shaped workpieces 15 in a single processing step.

The base workpiece 10 is thus divided by the processing tools such that a separating cut is made in each case between a pair of adjacent grooves 11, the separating cut being made at a distance from the adjacent grooves 11 such that the reference elements 16 facing one another are retained on the divided workpieces 15. In this way, once the base workpiece 10 has been divided, the reference elements 16 for subsequent processing steps to align the respective plate-shaped workpiece 15 and/or a processing device as well as the design elements 13 remain on the plate-shaped workpieces 15 in order to form the workpiece edges 15 formed by the design elements 13 on the finished workpieces 15.

In a sixth method step S6, a reference edge is formed on each of the divided plate-shaped workpieces 15, for example by means of a machining method, in order to form a defined contact surface or alignment surface for a subsequent processing step S7.

In this seventh method step S7, the narrow sides 22 of the plate-shaped workpieces 15 formed by dividing the base workpiece 10 are processed, in particular by machining, for example with a milling tool. The reference elements 16, the base portions 20 and any excess material on the narrow sides 22 of the plate-shaped workpieces 15 are substantially removed by means of this machining. When processing the narrow sides 22 of the workpieces 15, it is in particular provided that the design elements 13 on the respective plate-shaped workpieces 15 are retained without processing in order to form the workpiece edges 15 on the finished workpieces 15. The section that is removed from the plate-shaped workpieces 15 by method step S7 is shown by the dashed lines in FIGS. 3 and 4.

FIG. 5 shows a finished plate-shaped workpiece 15, the illustration showing that by means of the machining operation, corresponding connecting members 23, 24 are formed on the narrow sides 22 of the plate-shaped workpieces 15 formed by dividing the base workpiece 10. The corresponding connecting members 23, 24 can be formed circumferentially on the narrow sides 22 of the workpieces 15. The connecting members 23, 24 are produced as a groove and a correspondingly configured tongue in order to be able to connect the finished plate-shaped workpieces 15 with one another by means of a tongue and groove connection during a subsequent use, for example as floor panels. The design elements 13 remaining on the plate-shaped workpieces 15 form a visually appealing and high-quality workpiece edge 14 between the connected workpieces 15.

It is apparent to the person skilled in the art that individual features described in different embodiments may also be implemented in a single embodiment, provided that they are not structurally incompatible. Similarly, various features described in the context of a single embodiment may also be provided in several embodiments either individually or in any suitable sub-combination.

1. A method for producing plate-shaped workpieces preferably consisting at least in parts of wood, a wood material, plastic, composite material and/or mixed material or the like, said method comprising the steps of:
providing a plate-shaped base workpiece,
introducing at least one groove into a surface of the base workpiece, at least one design element and at least one reference element being formed when introducing the groove,
aligning the base workpiece and/or a processing device in dependence on the at least one reference element formed, and
dividing the base workpiece into at least two plate-shaped workpieces.

2. The method according to claim 1, wherein the base workpiece is furthermore divided such that the at least one design element and the at least one reference element are retained on at least one of the at least two plate-shaped workpieces.

3. The method according to claim 1, wherein the at least one design element and the at least one reference element are furthermore formed at a distance to one another and/or at least in sections along a longitudinal extension of the at least one groove.

4. The method according to claim 1, wherein the at least one design element and the at least one reference element are furthermore formed at a distance of at most 5 mm, preferably at most 3 mm, more preferably at most 2 mm.

5. The method according to claim 1, wherein the at least one design element is furthermore formed at an edge region of the at least one groove, preferably as a chamfer, a rebate, a shoulder, a rounding or the like, and/or the at least one reference element (16) is formed at an opposite edge region of the at least one groove, preferably as an edge, a surface, an inclined surface or the like.

6. The method according to claim 1, wherein the at least one reference element, in particular the reference element formed as an inclined surface, is furthermore formed so as to be inclined at an angle of inclination of at least 40°, preferably at least 50°, more preferably at least 60°, relative to a main plane of extension of the plate-shaped base workpiece.

7. The method according to claim 1, wherein at least one pair of adjacent grooves is furthermore introduced into the surface of the base workpiece, the reference elements being formed at the facing edge regions of the pair of adjacent grooves and the base workpiece being divided into the plate-shaped workpieces between the reference elements of the pair of adjacent grooves.

8. The method according to claim 7, wherein at least the design elements of the pair of adjacent grooves are furthermore formed mirror-symmetrical to one another.

9. The method according to claim 7, wherein a plurality of pairs of adjacent grooves are furthermore introduced into the surface of the base workpiece and the base workpiece is in each case divided into a plurality of plate-shaped workpieces between the reference elements of a pair of adjacent grooves.

10. The method according to claim 7, wherein the surface of the base workpiece is furthermore printed and/or coated, at least in some areas, after introduction of the at least one groove and before division of the base workpiece, wherein a printing unit preferably for printing and/or coating is aligned in dependence on the at least one reference element.

11. The method according to claim 7, wherein the narrow sides of the plate-shaped workpieces formed by dividing the base workpiece are furthermore processed such that the at least one reference element is removed preferably by machining, and the at least one design element is retained as the workpiece edge of the plate-shaped workpiece.

13. Processing machine for producing plate-shaped workpieces preferably consisting at least in parts of wood, a wood material, plastic, composite material and/or mixed material or the like, in particular according to the method according to claim 1, said processing machine comprising:
a conveying device for bringing about a conveying movement of a base workpiece,
a processing device for introducing at least one groove into a surface of the base workpiece, the processing device comprising at least one processing tool by means of which at least one design element and at least one reference element can be formed when introducing the at least one groove,
at least one processing tool for dividing the base workpiece into at least two plate-shaped workpieces, and
an aligning device by means of which the base workpiece and/or the at least one processing tool for dividing the base workpiece can be aligned in dependence on the at least one reference element.

14. The processing machine according to claim 13, wherein at least one printing unit is furthermore provided between the processing device for introducing the at least one groove and the at least one processing tool for dividing the base workpiece, the printing unit being alignable in dependence on the at least one reference element in order to print and/or coat the surface of the base workpiece at least in some areas.

15. The processing machine according to claim 13, wherein at least one processing unit is furthermore provided, by means of which the narrow sides of the plate-shaped workpieces formed by dividing the base workpiece can be processed such that the at least one reference element is removed preferably by machining, and the at least one design element is retained as the workpiece edge of the plate-shaped workpiece.
